(19) United States
(12) Patent Application Publication
(10) Pub. No.: US 2005/0096836 A1
(43) Pub. Date: May 5, 2005

(54) Vehicle operation information management evaluation system

(76) Inventors: Katsuaki Minami, Nagano-shi (JP); Satoshi Sakaguchi, Nagano-shi (JP)

Correspondence Address: RABIN & Berdo, PC, 1101 14TH STREET, NW, SUITE 500, WASHINGTON, DC, 20005, US

(21) Appl. No.: 10/504,423

(22) PCT Filed: May 14, 2003
(86) PCT No.: PCT/JP03/06019

(30) Foreign Application Priority Data
May 16, 2002 (JP) 2002-141522

(51) Int. Cl. G06G 7/76

(52) U.S. Cl. 701/123

(57) ABSTRACT

An operation management system is provided, which includes a database (105) that accumulates operation information, including a fuel consumption amount, that is gathered from a running vehicle (A1 to B2) through a network (20); and a management device (103, 104) that sends the gathered operation information and the operation information accumulated in the database (105) to a client computer (A10, B10) through the network (20). The management device (103, 104) receives an instruction for the vehicle (A1 to B2) from the client computer (A10 and B10), and sends the received instruction to the vehicle (A1 to B2).

### FIELD TO WHICH THE INVENTION BELONGS

The present invention relates to a vehicle operation information management and evaluation system that uses a network.

### BACKGROUND OF THE INVENTION

With vehicle operation management in a company, office, or the like, operation management is performed by operation records for each vehicle and by driver reports. Operation instruction is, performed by verbal reports or written documents of a manager based upon the operation records and the driver reports.

### SUMMARY OF THE INVENTION

With a conventional method, however, evaluation and instruction are performed based on past information. A driver cannot be instructed in real time based on acquired information relating to a current running state, and it is thus difficult to perform instruction that is sufficient and accurate. Further, for cases where instruction of the driver is performed while an instructor is riding in the same vehicle as the driver, a large number of instructors become necessary for companies and offices that have a large number of vehicles and drivers. Expenses thus escalate. Furthermore, the instruction depends upon the experience of the instructor, and it is difficult to perform instruction objectively in determining just how to improve driving operations.

It is therefore an object of the present invention to perform operation management, evaluation, and instruction on vehicles used by users, such as companies and offices, through a network, thus promoting economic operation and reducing the burden on the environment. It is a further object of the present invention to perform operation management, evaluation, and instruction objectively.

According to the present invention, a vehicle operation information management and evaluation system includes a database that accumulates operation information, including a fuel consumption amount, that is gathered from a running vehicle through a network and a management device that sends the operation information accumulated in the database to a client computer through the network. The management device receives an instruction for the vehicle from the client computer and sends the received instruction to the vehicle.

Therefore, according to the present invention, operation information for a vehicle that is running is accumulated in a database through a network, and is sent to a client computer. A manager can monitor the operation information, including a fuel consumption amount, in real time without riding in the same vehicle, and can send instructions to the driver. In particular, users such as companies and offices that manage a large number of drivers can thus perform instruction efficiently, and furthermore, can promote economic operation and reduce the burden on the environment through the instruction.

Embodiments of the present invention and advantages of the present invention are explained in detail below while referring to the appended drawings.

### BRIEF DESCRIPTION OF THE DRAWINGS

FIG. 1 is a block diagram that shows a vehicle operation information management and evaluation system of the present invention.

FIG. 2 is a block diagram that shows a configuration of an on-board instrument.

FIG. 3 is a diagram that shows a configuration of a database of an operation information management site.

FIG. 4 is a diagram that shows a login screen.

FIG. 5 is a diagram that shows a menu screen.

FIG. 6 is a diagram that shows a screen for selecting a vehicle and a driver.

FIG. 7 is a diagram that shows a screen that displays a driving state and a running location.

FIG. 8 is a diagram that shows an evaluation method selection screen.

FIG. 9 is a diagram that shows a screen that displays data relating to economic operation of a certain driver as a graph.

FIG. 10 is a diagram that shows a screen that displays data relating to economic operation of a plurality of drivers as a table.

### DESCRIPTION OF THE PREFERRED EMBODIMENTS

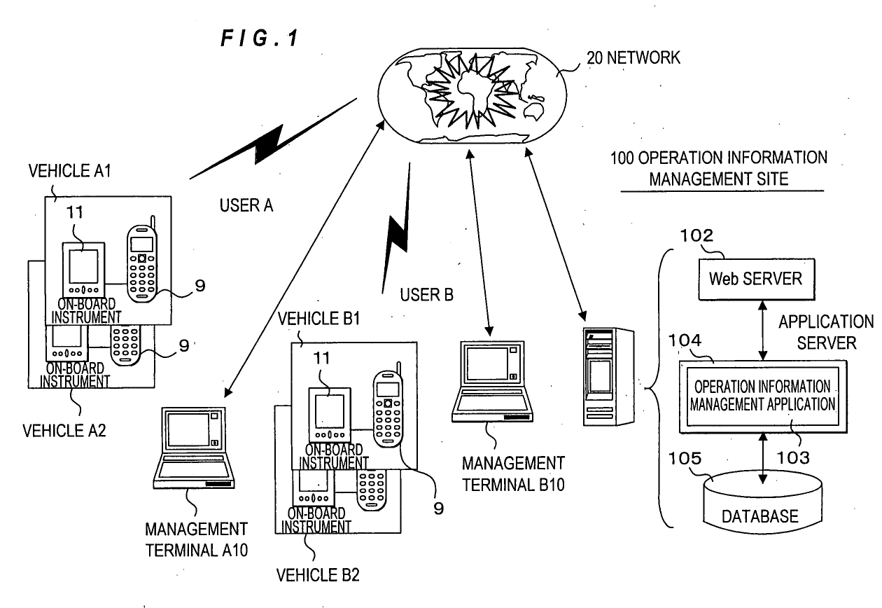

Referring to FIG. 1 of the drawings, FIG. 1 shows a vehicle operation information management and evaluation system of the present invention. An operation information management site 100 is configured around a Web server 102, an application server 104 that runs an operation information management application 103, and a database 105 that accumulates vehicle operation information, user information, and the like. The operation information management site 100 is connected to a network 20 such as the Internet. Further, users A and B of the operation information management site 100 are companies, offices, and the like that operate a plurality of vehicles A1 to B2.

The operation information management application 103 acquires operation information for the vehicles A1 to B2 of the users A and B from an on-board instrument 11 that is installed in the vehicles A1 to B2, through a wireless communication device 9 and the network 20. The operation information is accumulated in the database 105. Operation states of a driver (accelerator depression amount, brake operation amount, gear shift lever operation), operation states of the vehicle (vehicle speed, running distance, amount of fuel consumed), a current location of the vehicle, and the like are included in the operation information.

Further, the operation information management application 103 tabulates and analyzes the accumulated data, and then sends the tabulated and analyzed data to management terminals A10 and B10 (client computers), which are capable of accessing the operation information management site 100 through the network 20, in response to requests from the management terminals A10 and B10. In addition, the operation information management application 103 performs bi-directional communication with the on-board instrument 11 of an arbitrary vehicle of the vehicles A1 to B2, and transfers instructions from the management terminals A10 and B10 to the on-board instrument 11 of the vehicles A1 to B2, in response to requests from the management terminals A10 and B10. Operation instruction of arbitrary vehicles is thus achieved in real time by the management terminals A10 and B10. It should be noted that the operation information management application 103 sends and receives information through the Web server 102.

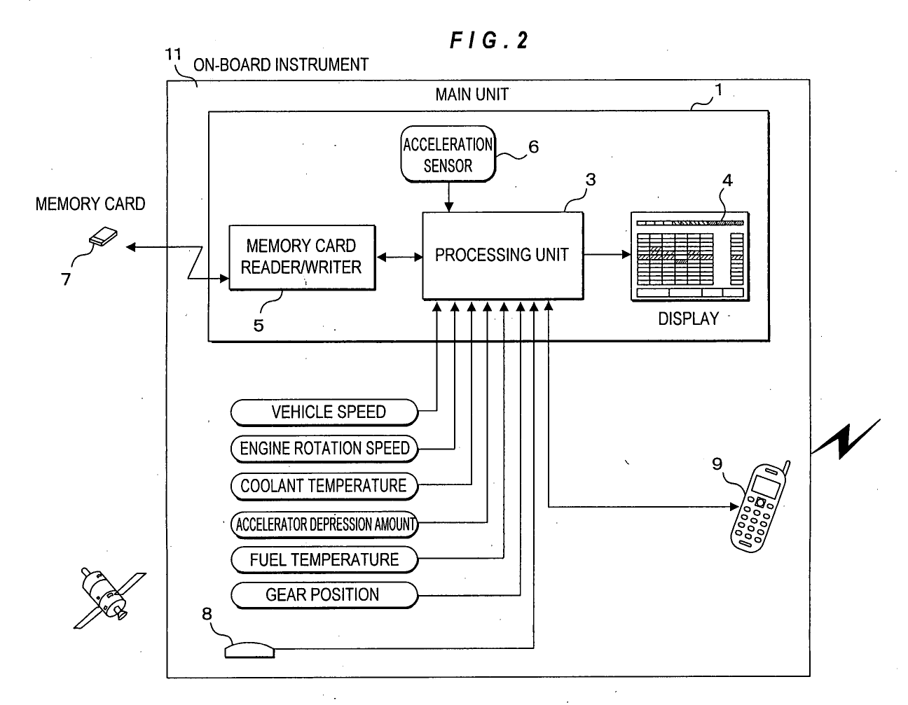

Referring to FIG. 2, the on-board instrument 11 is explained next.

The on-board instrument 11 includes a main unit 1, a positioning system 8 that uses the GPS, and the wireless communication device 9 that is capable of connecting to the network 20. A portable telephone can be used for the wireless communication device 9.

The main unit 1 includes a processing unit 3, a display 4, a memory card reader/writer 5, and an acceleration sensor 6. The display 4 is installed in the vehicle in a position that is easily viewable by the driver.

Signals that express the vehicle speed, the engine rotation speed, the engine coolant temperature, the accelerator depression amount, the fuel temperature, and the gear shift lever position (gear position), which are output from the vehicle, and a signal that expresses the amount of vehicle acceleration, which is output from the acceleration sensor 6, are input to the processing unit 3. The vehicle output signals can be acquired from an engine control unit and a transmission control unit that are not shown. The vehicle output signals may also be acquired directly from sensors attached to the vehicle, without passing through these units.

The processing unit 3 computes driving states such as the amount of fuel consumption based on each of the signal types described above, vehicle specification original data read from the memory card 7, maps that show engine fuel economy characteristics, and the like. Further, the processing unit 3 computes the current vehicle location (latitude, longitude, and elevation) based on information that the positioning system 8 receives from GPS satellites. The processing unit 3 displays the computed driving states on the display 4, and sends the driving states and the vehicle location to the operation information management site 100 through the wireless communication device 9. Further, the computed driving states and vehicle location are recorded in a memory card 7 by the memory card reader/writer 5.

With a vehicle equipped with a navigation system, instead of using the positioning system 8, the vehicle position that is detected by the navigation system may also be input to the processing unit 3.

The fuel consumption amount, the fuel economy, the excess fuel consumption amount, and the like are included in the driving states described above. An outline for each of the driving states is shown below.

(1) Amount of Fuel Consumption, Fuel Economy

By preparing a map in advance that prescribes a relationship among the accelerator depression amount, the engine rotation speed, and the fuel consumption rate, for example, the fuel consumption amount may be computed based on the fuel consumption rate obtained by referring to the map. The method of computing the fuel consumption amount may also employ other methods, such as a method of using a fuel injection pulse width. The fuel economy is computed based on the amount of fuel consumption and running distance (value found by integrating the vehicle speed).

(2) Excess Drive Force, Excess Drive Force Rate

Excess drive force is a value in which the running resistance (value that excludes the accelerating resistance) is subtracted from the driving force transmitted from the engine. The vehicle is decelerating if the excess drive force is negative, and is accelerating if the excess drive force is positive. For cases where the excess drive force is extremely large, it is determined that a wasteful driving force is acting, and that it is necessary to quickly perform an upshift or to reduce the accelerator depression amount. The excess drive force rate is a ratio of the excess drive force to the running resistance.

(3) Excess Fuel Consumption Amount

In addition to fuel consumed in order to generate the excess drive force described above, the excess fuel consumption amount also includes the amount of excess fuel that is consumed due to driving that worsens the fuel economy (such as idling and engine racing). The excess fuel consumption amount is the difference between the amount of fuel that is actually consumed and the fuel consumption amount for a case where driving that worsens fuel economy is not performed. The degree that excess fuel is consumed can be found by referring to the excess fuel consumption amount. In other words, it is possible to find the amount of fuel that can be saved by improving driving operations.

(4) Judgment of Acceleration and Hard Acceleration

For cases where an acceleration computed from the vehicle speed, or an acceleration detected by the acceleration sensor 6, is compared to an acceleration judgment value (set to 0.2 [m/sec²], for example) or a hard acceleration judgment value (set to 0.7 [m/sec²], for example), and the detected acceleration exceeds the acceleration judgment value, it is determined that acceleration is being performed. For cases where the detected acceleration value exceeds the hard acceleration judgment value, it is determined that hard acceleration is being performed. Further, for cases where an excess drive force rate is used in judging acceleration and hard acceleration, it is determined that acceleration is being performed when the excess drive force rate is positive, and it is determined that hard acceleration is being performed when a predetermined excess drive force rate (set to 40%, for example) is exceeded. The hard acceleration judgment value changes according to a driving rank that shows the driving skill of the driver, and the value is set smaller as the driving rank becomes higher. The amount of time that acceleration is being performed and the amount of time that hard acceleration is being performed are each sent to the operation information management site 100, and further, are each recorded in the memory card 7.

(5) Judgment of Deceleration and Sudden Deceleration

Similar to the judgment of the acceleration and the hard acceleration as described above, it is judged that deceleration is being performed when a detected deceleration amount is larger than a deceleration judgment value (for example, 0.2 [m/sec²]). In addition, it is judged that sudden deceleration is being performed when the deceleration amount is larger than a sudden deceleration judgment value (for example, 0.7 [m/sec²]). Further, for cases where the excess drive force rate is used in judging deceleration and sudden deceleration, it is determined that deceleration is being performed when the excess drive force rate is negative, and it is determined that sudden deceleration is being performed for cases where the excess drive force rate is equal to or less than a predetermined excess drive force rate (set to −400%, for example). The sudden deceleration judgment value changes according to the driving rank that shows the driving skill of the driver, and the value is set smaller as the driving rank becomes higher. The amount of time that deceleration is being performed and the amount of time that sudden deceleration is being performed are each sent to the operation information management site 100, and further, are each recorded in the memory card 7.

(6) Judgment of Idling

When the vehicle is stopped continuously for a predetermined period of time, for example a period of time equal to or greater than 20 seconds, and the engine rotation speed is equal to or less than an idling judgment threshold value, it is determined that the vehicle is idling. The predetermined period of time is set to a period that excludes short time stops while waiting at a traffic signal. Further, the idling judgment threshold value is set to a value that is smaller than the engine speed during increased idling so as to exclude increased idling occasions where the engine output force is utilized to drive a cargo crane or the like. When the engine is judged to be idling, the amount of idling time is measured. The measured amount of time is then sent to the operation information management site 100, and further, is recorded in the memory card 7. Furthermore, the number of vehicle stops, the amount of vehicle stopping time, the number of engine stops, the amount of time that the engine is stopped, and the like are computed by the operation information management site 100 based on the received information that shows that the vehicle is idling, and are recorded in the database 105.

(7) Judgment of Overspeed

Overspeed judgment is performed by comparing the vehicle speed to a regulated vehicle speed. When the vehicle exceeds a regulated vehicle speed, it is judged that an overspeed has occurred. A manager can arbitrarily set the regulated vehicle speed. For example, the regulated vehicle speed may be set to 60 [km/hour] when running on a local street, and to 80 [km/hour] when running on an express highway. The regulated vehicle speed that has been set is sent to the operation information management site 100, and managed for each individual user. When it is determined that there is an overspeed, the amount of time that the vehicle ran at the overspeed is sent to the operation information management site 100, and further, is recorded in the memory card 7.

(8) Judgment of Upshift Capability

The engine rotation speed and the maximum drive force for a one gear upshift are calculated. When the engine rotation speed for a case where an upshift is assumed to occur is equal to or greater than a regulated value, and the maximum drive force after the upshift is equal to or greater than the current running resistance, it is judged that an upshift is possible. For cases where an upshift is judged to be possible, the amount of time during which the upshift is possible is sent to the operation information management site 100, and further, is recorded in the memory card 7. Furthermore, the gear position used during acceleration, and the amount of time at which the vehicle has run at the gear position, are sent to the operation information management site 100, excluding the highest transmission gear (for cases of a five-speed transmission in a forward direction, first gear, second gear, third gear, and fourth gear are applied).

(9) Judgment of Uniform Speed Running

A judgment of whether or not the vehicle is running at uniform speed is made based on the excess drive force and the excess drive force rate. For cases where a state in which the excess drive force or the excess drive force rate is smaller than a predetermined value continues for an amount of time equal to or greater than a fixed amount of time, it is judged that the vehicle is running at uniform speed. The amount of time at which the vehicle is judged to be running at uniform speed is sent to the operation information management site 100, and further, is recorded in the memory card 7. Furthermore, the operation information management site 100 also records the total running time in order to investigate the frequency of uniform speed running with respect to the total amount of running time.

(10) Judgment of Engine Racing

A judgment as to whether or not engine racing is performed is made based on the vehicle speed, the engine rotation speed, and the accelerator depression amount. For cases where the engine rotation speed and the accelerator depression amount are not zero, even though the vehicle speed is zero, it is judged that engine racing is being performed. The number of times that engine racing occurs is sent to the operation information management site 100, and is recorded in the memory card 7. The operation information management site 100 records the number of times that engine racing is performed.

The processing unit 3 thus computes running states such as the fuel consumption amount, the fuel economy, the excess drive force, the excess drive force rate, the excess amount of fuel consumption, the hard acceleration, the sudden deceleration, the idling, the overspeeds, the possible upshift states, the uniform speed running, and the engine racing. The processing unit 3 displays the current driving state on the display 4. Excess depression of the accelerator pedal, delays in upshifting, wasteful acceleration, and the like are thus made known to the driver, and information for performing economic driving is imparted to the driver.

Further, the processing unit 3 sends the information relating to the driving states described above to the operation information management site 100 through the wireless device 9 and the network 20. The operation information management application 103 stores the received running information in the database 105. In addition, the operation information management application 103 analyzes the stored running information and assesses the running states for each driver and each vehicle.

A URL for connecting to the operation information management site 100, ID and password driver information (personal information), vehicle information, and the like are recorded in advance in the memory card 7. The processing unit 3 logs in to the operation information management site 100 through the wireless communication device 9 and the network 20 based on the information that is recorded in the memory card 7, and sends the running information to the operation information management site 100. Sending of the data from the main unit 1 to the operation information management site 100 may be performed at predetermined intervals of time, or may be performed when a predetermined amount of data (several tens of kilobytes, for example) has been accumulated in the processing unit 3.

The operation information management application 103 of the operation information management site 100 provides the following services.
(A) Driver instruction by bi-directional communication
(B) Running information statistics
(C) Evaluation of running states, and comparative evaluation of driving record data
(D) Management support duties

First, accumulation of data in the database 105 in order to perform each of the services described above is explained.

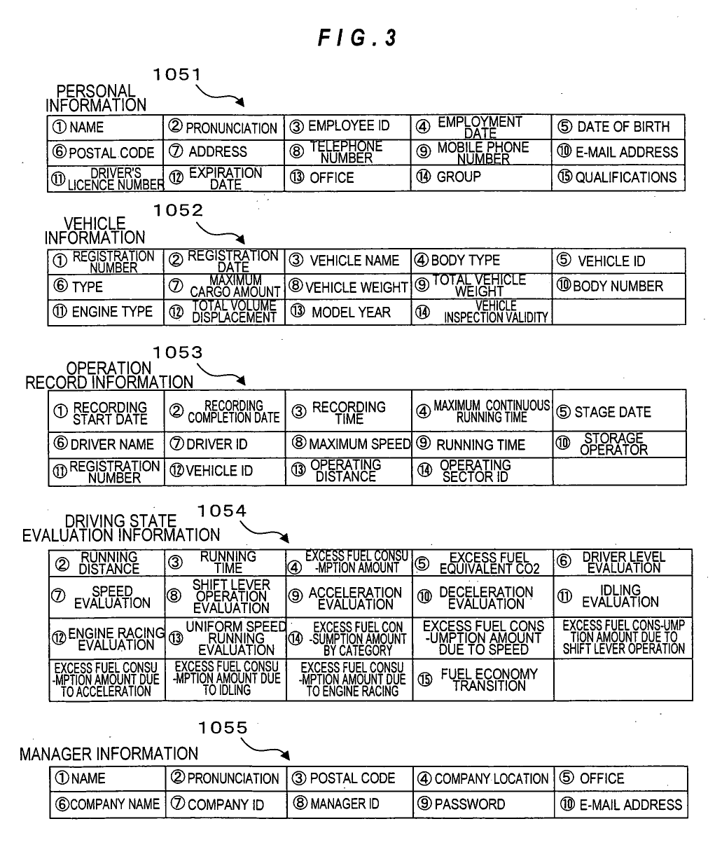

Referring to FIG. 3, data that is accumulated or updated in the database 105 is roughly classified as personal information 1051, vehicle information 1052, running record information 1053, running state analysis information 1054, manager information 1055, and company information, which is not shown.

Information on employees such as drivers is stored in the personal information 1051. Information such as name and employee ID is stored, and the information is managed for each user. Information such as vehicle registration number and vehicle ID is stored in the vehicle information 1052, and the information is managed for each user.

The running record information 1053 is generated each time a vehicle is run, based on personal information such as driver name and driver ID (employee ID), and vehicle information such as the registration number and the vehicle ID. The running record information 1053 is stored as information on the date and time that running starts, the date and time that running finishes, the travel time, the maximum continuous travel time (amount of time that the vehicle continues to run without stopping), the running distance, a running sector ID, and the like. After the ignition of the vehicle is turned on and the on-board instrument 11 starts up, a record of the running record information 1053 is generated based on the driver ID, the vehicle ID, and the like, which are recorded in the memory card 7. The running sector ID is an ID code for a running route that is set depending on each user. For example, the running sector ID is set based on starting point, routing locations, and finishing point position information.

The driving state evaluation information 1054 is generated corresponding to one record of the running record information 1053. The driving state evaluation information includes the excess fuel consumption amount, a value in which the excess fuel consumption is converted into a CO₂ emission amount, a driver level evaluation, a speed evaluation, a gear shift lever operation evaluation, an acceleration evaluation, a deceleration evaluation, an idling evaluation, an engine racing evaluation, a uniform speed running evaluation, and the like. The operation information management application 103 updates each item of information based on the running information that is received from the on-board instrument 11.

Referring to FIG. 1, the manager information 1055 stores information that relates to managers who operate the management terminals A10 and B10 and utilize the operation information management site 100. For example, the manager information 1055 stores manager IDs, passwords, and company IDs needed in order to perform authentication when the management terminals A10 and B10 log in to the operation information management site 100.

Content for each service is explained next.

(A) Driver Instruction by Bi-Directional Communication

This is a service whereby instruction relating to driving operations for running vehicles is performed in real time from the management terminals A10 and B10. Referring to FIG. 1, a case in which instruction is performed from the management terminal A10 of the user A to the running vehicle A1 is explained. Cases in which instruction is performed to the vehicle A2 during running, and where instruction is performed from the management terminal B10 of the user B to the vehicles B1 and B2 during running, are similar to the above case.

First, the management terminal A10 connects to the operation information management site 100 through the network 20 by using a browser.

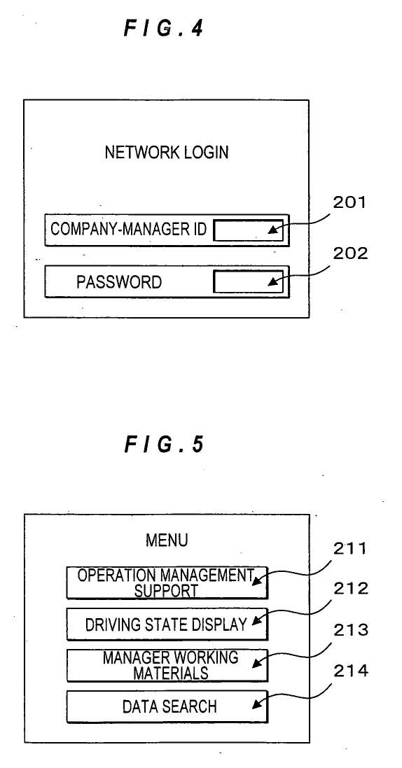

The operation information management application 103 of the operation information management site 100 sends a login screen shown in FIG. 4 to the management terminal A10 according to a connection request. The manager inputs the company ID, the manager ID, and the password into predetermined columns 201 and 202 from the management terminal A10, and performs authentication. The operation information management application 103 sends a menu screen shown in FIG. 5 to the management terminal A10 when the authentication is complete.

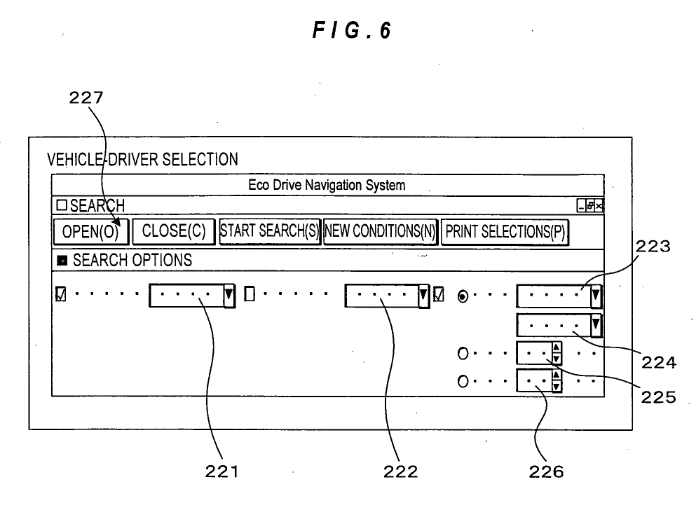

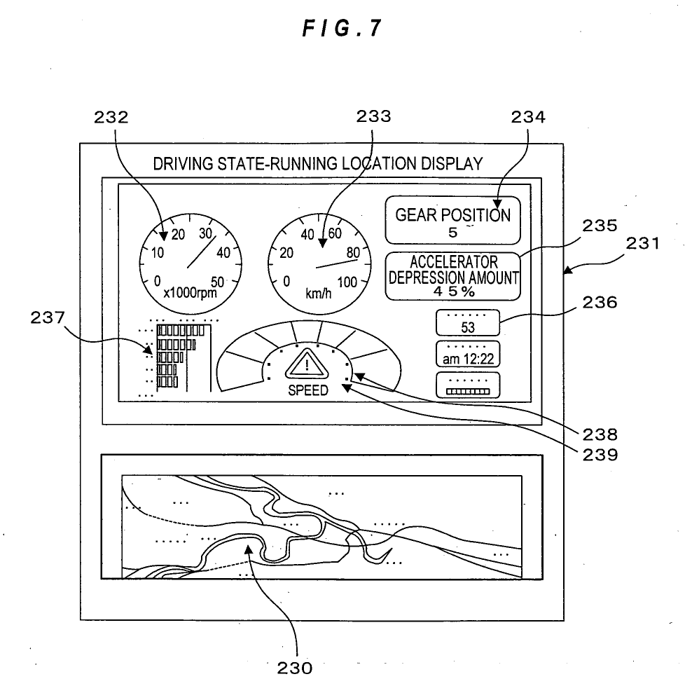

Any one of items 211 to 214 that are displayed in the menu screen can be selected by the management terminal A10. As shown in FIG. 6, when the item 212 is selected, a vehicle-driver selection screen is displayed on the management terminal A10. In addition, when any one of driver codes 221 and vehicle codes 222 is specified on this screen and an “open” button 227 is pressed, as shown in FIG. 7, the specified driver and vehicle driving state are displayed. For cases where a time period is specified by use of boxes 223 to 226, the driving state evaluation and the running record can be referenced over the specified period for the driver or the vehicle that is specified by the driver code 221 or the vehicle code 222, respectively.

The running information of the vehicle A1 that the manager specifies is sent to the management terminal A10 via the operation information management site 100, and is displayed as shown in FIG. 7 on a display device of the management terminal A10 with almost no delay.

The manager can monitor the driving states of the vehicle A1, road information (traffic congestion information), and running point (identified as mountain pass, express highway, local street) in real time on the screen of the management terminal A10. Further, the operation information management application 103 analyzes the running information that is sent from the vehicle A1, accumulates the analyzed information in the database 105, and sends the analyzed information to the management terminal A10. Furthermore, the operation information management application 103 sends (forwards) instructions from the management terminal A10 to the on-board instrument 11. Bi-directional communication can thus be performed in real time between the management terminal A10 of the user A and the on-board unit 11 of the vehicle A1, through the operation information management site 100.

As shown in FIG. 7, a map display portion 230 that displays the running point of the specified vehicle A1, and a meter portion 231 that displays each of the driving states, are shown in the display device of the management terminal A10. The meter portion 231 includes an engine rotation speedometer 232 that displays the engine rotation speed of the vehicle, a speedometer 233 that displays the vehicle speed, a gear position meter 234 that displays the gear shift lever position of the vehicle, an accelerator pedal depression amount meter 235 that displays the amount that the accelerator pedal is depressed, an excess fuel consumption meter 236 that displays the excess fuel consumption amount computed by the processing unit 3 of the on-board instrument 11, a level meter 238 that displays the driving level of the driver, a fuel economy meter 237 that displays the fuel economy computed by the processing unit 3, and a warning display portion 239 that displays warnings.

Maps that are displayed in the map display portion 230 are sent to the management terminal A10 by the operation information management application 103. The operation information management application 103 selects a map of a corresponding region from map information, which is stored in a map database, based on the current location of the vehicle computed by the processing unit 3. The operation information management application 103 adds the current location of the vehicle A1 to the selected map and sends the map to the management terminal A10.

The manager operating the management terminal A10 monitors the driving states that are displayed in the display device of the management terminal A10. When the manager has an instruction on a warning point, an instruction point, or the like for the driver, the manager sends the instruction through an input device such as a keyboard of the management terminal A10. The operation information management application 103 temporarily receives the instruction from the management terminal A10. Next, the operation information management application 103 sends the instruction to the wireless communication device 9 of the vehicle A1 that the management terminal A10 is monitoring. The display 4 of the main unit 1 then displays the instruction that the wireless communication device 9 has received.

The manager can thus perform instruction of the driver in real time without riding in the same vehicle A1. For example, the running information of the vehicle A1 that is sent form the operation information management site 100, in particular information relating to economic driving, may be monitored. An instruction may be sent relating to what type of driving operations will allow the vehicle to arrive at its destination while consuming the least amount of fuel necessary.

Further, by acquiring the location of the vehicle along with the amount of fuel consumed, the operation information management site 100 can accumulate the fuel consumption amount in the database 105 for each running route (running sector). The manager can inspect changes in fuel economy due to the running route as information. Therefore, the manager can instruct the driver as to which running route will improve the fuel economy, and the fuel economy can increase further. In addition, by making the fuel economy information according to the running route into a database, the information can be sent to all of the users.

The manager can send instructions in real time while looking at the driving states of arbitrary vehicles by using the management terminal A10. Accordingly, the efficiency relating to instruction can be increased in a company or an office that manages many drivers. Further, economic driving can be promoted by the instructions, and the burden on the environment can decrease.

The operation information management site 100 may also provide running information on a plurality of vehicles at the same time to the management terminal A10. In this case, the running information of a plurality of drivers and vehicles can be monitored at one management terminal A10, and instruction can be performed to each of the drivers. Accordingly, the efficiency relating to instruction can be further increased.

In addition to transmitting the instructions to the vehicle A1 by a message format that is input from a keyboard or the like, the instructions may also be transmitted to the driver by using audio, images, or the like.

As described above, the operation information management site 100 gathers, accumulates, and analyzes running information on the vehicles A1 to B2, that are managed by the plurality of users A and B. The operation information management site 100 sends necessary information to the management terminals A10 and B10 of the users A and B, respectively. It is therefore not necessary for the users to gather, accumulate, and analyze the running information by themselves. That is, by simply installing the on-board instruments 11 in the vehicles, and by installing the management terminals A10 and B10 in the company, the office, or the like, the users can perform management and evaluation of information. The costs necessary for installation of the running information management and evaluation system can thus be curtailed.

(B) Running Information Statistics

With this service, the operation information management site 100 performs analysis of the running information that is collected from the vehicles, and provides reports relating to economic driving and running records to each user like those discussed below.
a. Driver evaluation and instruction (in units of one day, one week, one month, and one year)
b. Office evaluation (in units of one day, one week, one month, and one year)
c. Company evaluation (in units of one day, one week, one month, and one year)
d. Aggregate management of running information for each driver by running record function (in units of one day, one week, one month, and one year)
e. Aggregate management of running information per office (in units of one day, one week, one month, and one year)
f. Aggregate management of running information for an entire company (in units of one day, one week, one month, and one year)
g. Creation of an instruction table per driver, and an evaluation table for the offices and the company

(C) Evaluation of Running States, and Comparative Evaluation of Driving Record Data

With this service, the operation information management site 100 classifies the information accumulated from each user, and creates statistics.

The users can perform comparative evaluation by using the management terminals A10 and B10 and arbitrarily selecting data in the operation information management site 100. Further, necessary information can be acquired from all of the data by searching.

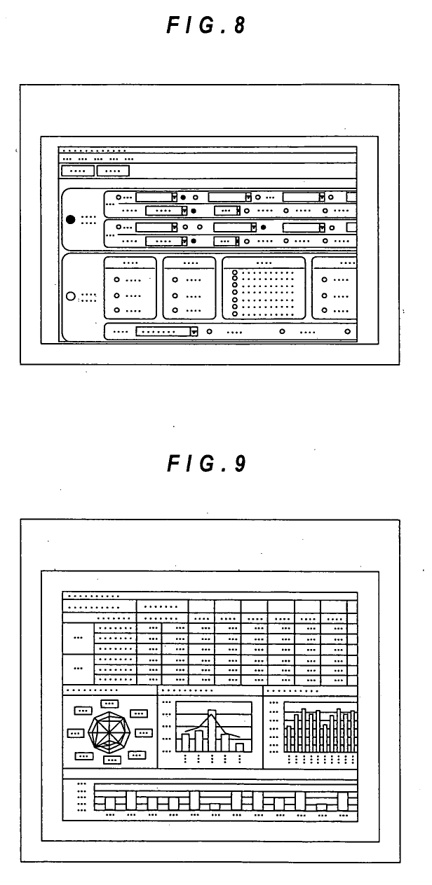

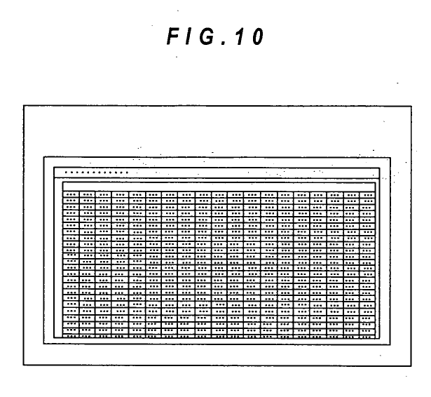

In addition, the operation information management site 100 can receive requests from the users, and can provide comparative evaluation information that corresponds to the request from among all of the data. Regarding the running information that is accumulated in the database 105, for example, when the item 211 is selected from the menu screen of FIG. 5, and a desired item in the selection screen of the evaluation method shown in FIG. 8 is selected, as shown in FIG. 9, data relating to the economic driving of a certain driver can be inspected in a graphical format. Alternatively, as shown in FIG. 10, data relating to the economic driving of a plurality of drivers can be inspected in a tabular format.

(D) Management Support Duties

In addition to the above, the operation information management site 100 performs analyses such as those described below on each user, and provides the analyses as supporting materials.

a. Environment Management

By driver, by vehicle, by office (yearly, monthly, daily, and comparisons with the same month during the previous year)
Items relating to fuel: fuel consumption amount, excess fuel consumption
Items relating to CO₂: amount of CO₂ emission corresponding to amount of fuel consumption, amount of CO₂ emission corresponding to excess fuel consumption
Items relating to target values: fuel consumption amount, target value for reduction of CO₂ emission amount

b. Quality Management
Document management

Creation of each type of data (running time, running route, cargo, cargo amount, running record, and the like) and storage thereof (yearly, monthly, daily, comparisons with the same month during the previous year), creation and storage of general documents (running request sheets, running instruction sheets, work completion sheets, delivery plans, delivery data answer sheets, and the like).

c. Transport Efficiency (Yearly, Monthly, Daily, Comparison with the Same Month During the Previous Year)
Physical efficiency (t/km, t/vehicle, t/person)
Monetary efficiency (general management fees, personnel expenses, fuel and oil costs, vehicle maintenance costs, depreciation costs, road usage fees, accident compensation costs, automobile lease costs, insurance costs, and facilities expenses)
Actual load rate
Usage comparison between local streets and express highways

d. Personnel Management (Yearly, Monthly, Daily, Comparison with the Same Month During the Previous Year)
Attendance data (running time, working days, intermission time, overtime and late night work time, number of times sleeping in vehicle, and the like)
Personnel evaluation data (driving level, running distance, cargo amount, accident history, and the like)

The running information is gathered from the on-board instrument 11 with the operation information management site 100. In particular, the data relating to economic driving is collected, analyzed, and accumulated in the database 105, and the results of the analysis are provided to the user. The user can thus objectively perform running management, evaluation, and instruction of the vehicle in use. This can promote economic driving, and can reduce the burden upon the environment.

An example in which a portion of the embodiment described above is changed is explained next.

With the embodiment described above, the instructor performs instruction from the management terminal A10 in the driver instruction service performed by bi-directional communication. In this alternative example, however, the operation information management application 103 automatically performs instruction of the driver and the vehicle.

In this case, the operation information management application 103 monitors the running information that is acquired from the on-board instruments 11 of the vehicles A1 to B2, and accumulated in the database 105. When the operation information management application 103 judges that there is a predetermined driving state that will cause the fuel consumption amount to increase, instructions are sent to each of the vehicles A1 to B2, through the on-board instruments 11, in order to suppress the increase in fuel consumption due to the driving state, thus performing driver instruction. In addition, the instruction content sent to the vehicles A1 to B2 is also sent to the management terminals A10 and B10, conveying the fact that driver instruction has been performed.

The instruction performed by the operation information management application 103 relates to, for example, overspeed, gear shift lever operation, acceleration, deceleration, idling, engine racing, and erratic running. When these driving conditions increase the amount of fuel consumption as described below, the operation information management site 100 performs automatic instruction of the driver, through the on-board instrument 11.

(1) Overspeed Analysis

The amount of time that the vehicle speed exceeds the regulated speed is added up, and the fuel consumption amount is judged to be increased for cases where the added up time exceeds a fixed amount of time, for example five minutes. An overspeed warning is then sent to the on-board instrument 11. The on-board instrument 11 then visually or aurally provides an instruction for reducing speed to the driver. Furthermore, the management terminals A10 and B10 are notified of the fact that instruction has been given to the driver of the vehicle. For example, the management terminals are notified of the driver name and the instruction content.

(2) Gear Shift Lever Operation Analysis

The amount of time during which an upshift is possible is totaled for each gear position. For cases where the amount of time that an upshift is possible exceeds a fixed amount of time, such as five minutes, the fuel consumption amount is judged to have increased. The operation information management site 100 then issues an instruction to the on-board instrument 11 to perform an upshift. The on-board instrument 11 visually or aurally urges the driver to perform an upshift. Furthermore, the management terminals are notified of the fact that the driver of the vehicle has been instructed. For example, the management terminals are notified of the name of the driver who has been instructed, and the instruction content.

(3) Acceleration Analysis

The amount of time spent at an acceleration equal to or greater than a standard acceleration value (for example, 0.78 [m/sec²]) is totaled at each gear position. Alternatively, the amount of time at an acceleration equal to or greater than a predetermined excess drive force rate (set to 40%, for example) is totaled. For cases where the total time exceeds a predetermined amount of time, for example five minutes, the fuel consumption amount is judged to have increased, and an instruction is sent to suppress the hard acceleration.

(4) Deceleration Analysis

The amount of time spent at a deceleration equal to or greater than a standard deceleration value (for example, 0.78 [m/sec²]) is totaled. Alternatively, the amount of time at deceleration equal to or less than a predetermined excess drive force rate (set to −400%, for example) is totaled. For cases where the total time exceeds a predetermined amount of time, for example five minutes, the fuel consumption amount is judged to have increased, and an instruction is sent to suppress the hard deceleration.

(5) Uniform Speed Running Analysis

The amount of time during which the excess driving force or the excess driving force rate is equal to or greater than a fixed value, or the amount of time during which the vehicle speed fluctuates, exceeding a standard fluctuation amplitude (5 to 10 [km/hour], for example), is totaled. For cases where the total time exceeds a fixed amount of time, for example five minutes, the fuel consumption amount is judged to have increased. An instruction is sent to stop the erratic running.

(6) Idling Analysis

The amount of idling time is totaled, and for cases where the total time exceeds a fixed amount of time, for example five minutes, the fuel consumption amount is judged to have increased. An instruction is sent to stop idling and to turn off the engine.

(7) Engine Racing Analysis

The number of times that the engine has been raced is totaled. For cases where the total number exceeds a fixed number of times, for example five times, the fuel consumption amount is judged to have increased, and an instruction to stop engine racing is sent.

The driving states of the vehicle are thus analyzed by the operation information management site 100, and instructions are sent automatically in the alternative example. The companies, the offices, or other users can thus always perform education of the drivers. Further, the costs of instructor personnel can be suppressed.

### INDUSTRIAL APPLICABILITY

According to the present invention, the operation management, evaluation, and instruction of vehicles used by users such as offices can be performed through a network. This is effective in promoting the economic driving, reducing the burden on the environment, and objectively evaluating the operation information.

1. A vehicle operation information management and evaluation system, comprising:
a database (105) that accumulates operation information, including a fuel consumption amount, that is gathered from a running vehicle (A1 to B2) through a network (20); and
a management device (103, 104) that sends the operation information accumulated in the database (105) to a client computer (A10, B10) through the network (20), wherein
the management device (103, 104) functions to:
receive an instruction for the vehicle (A1 to B2) from the client computer (A10, B10); and
send the received instruction to the vehicle (A1 to B2).

2. A vehicle operation information management and evaluation system, comprising:
a database (105) that accumulates operation information, including a fuel consumption amount, that is gathered from a running vehicle (A1 to B2) through a network (20); and
a management device (103, 104) that sends the operation information accumulated in the database (105) to a client computer (A10, B10) through the network (20), wherein
the management device (103, 104) functions to:
judge whether or not the fuel consumption amount of the vehicle (A1 to B2) has increased, based on the operation information accumulated in the database (105); and
send an instruction that suppresses the increase in fuel consumption amount to the vehicle (A1 to B2), and reports to the client computer (A10, B10) that the instruction has been sent to the vehicle (A1 to B2), for cases where the fuel consumption amount is judged to have increased.

3. The vehicle operation information management and evaluation system according to claim 2, wherein the management device (103, 104):
judges a driving state under which the fuel consumption amount increases based on the operation information; and
sends an instruction to the vehicle (A1 to B2) for suppressing the increase in fuel consumption amount, according to the judged driving state, for cases where the driving state that increases the fuel consumption amount has been judged.

4. The vehicle operation information management and evaluation system according to claim 1, wherein the vehicle (A1 to B2) comprises:
a detecting device (3) that detects the operation information including the amount of fuel consumption; and
a communications device (9) that sends the detected operation information to the database (105) through the network (20), and receives instructions from the management device (103, 104) through the network 20.

5. A vehicle operation information management and evaluation system, comprising:
database means (105) that accumulates operation information, including a fuel consumption amount, that is gathered from a running vehicle (A1 to B2) through a network (20); and
management means (103, 104) that sends the operation information accumulated in the database means (105) to a client computer (A10, B10) through the network (20), wherein
the management means (103, 104):
receives an instruction for the vehicle (A1 to B2) from the client computer (A10, B10); and
sends the received instruction to the vehicle (A1 to B2).

6. The vehicle operation information management and evaluation system according to claim 2, wherein the vehicle (A1 to B2) comprises:
a detecting device (3) that detects the operation information including the amount of fuel consumption; and
a communications device (9) that sends the detected operation information to the database (105) through the network (20), and receives instructions from the management device (103, 104) through the network 20.

7. A vehicle operation information management and evaluation system, comprising:
database means (105) that accumulates operation information, including a fuel consumption amount, that is gathered from a running vehicle (A1 to B2) through a network (20); and
management means (103, 104) that sends the operation information accumulated in the database means (105) to a client computer (A 10, B 10), through the network (20), wherein
the management means (103, 104):
judges whether or not the fuel consumption amount of the vehicle (A1 to B2) has increased, based on the operation information accumulated in the database means (105); and
sends an instruction that suppresses the increase in fuel consumption amount to the vehicle (A1 to B2), and reports to the client computer (A10, B10) that the instruction has been sent to the vehicle (A1 to B2), for cases where the fuel consumption amount is judged to have increased.
